(19) United States
(12) Patent Application Publication
(10) Pub. No.: US 2009/0257796 A1
(43) Pub. Date: Oct. 15, 2009

(54) NANOTECHNOLOGY BASED IMAGE REPRODUCTION DEVICE

(75) Inventors: John C. Colvin, The Woodlands, TX (US); Daniel Bullock, The Woodlands, TX (US); Richard C. Haut, The Woodlands, TX (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: Houston Advanced Research Center, The Woodlands, TX (US)

(21) Appl. No.: 12/421,225

(22) Filed: Apr. 9, 2009

Related U.S. Application Data
(60) Provisional application No. 61/043,629, filed on Apr. 9, 2008.
(60) Provisional application No. 61/093,776, filed on Sep. 3, 2008.
(60) Provisional application No. 61/106,694, filed on Oct. 20, 2008.

(51) Int. Cl. G03G 15/20

(52) U.S. Cl. 399/336; 977/742

(57) ABSTRACT

An image reproduction device (e.g., a photocopy machine) uses carbon nanotube material and a microwave generator(s) to heat internal rollers to “set” image colorant/toner. The ability to rapidly heat the nanotube material with relatively low-power microwave generators permits the development of power efficient image reproduction devices. The principle of heating carbon nanotube material embedded within a roller with microwave energy may also be used in a number of other applications such as, for example, laminating, embossing, drying, annealing, calendering, and film orientation. In these embodiments, the material being processed or heated may be paper, film, plastic, rubber, film and the like.

This application claims priority to U.S. provisional patent application 61/043,629 entitled “Heating of Copy Machine Fusing Roller by Carbon Nanotube Absorption of Microwave Radiation” (filed 9 Apr. 2008). This application is also related to the following provisional patent applications: 61/093,776 entitled “Microwave Heating Using Carbon Nanotechnology” (filed 3 Sep. 2008) and 61/106,694 entitled “A Novel Infrared (IR) Heater to Reduce Energy Consumption While Maintaining Thermal Quality for Personnel Working in a Commercial Building Environment” (filed 20 Oct. 2008). Each of these applications are hereby incorporated by reference.

### BACKGROUND

Heating in the temperature range of approximately 100° C. (210° F.) to 600° C. (1,110° F.) is required for a large number of processes used in industrial, commercial, and residential settings. A large number of heat producing devices have been developed to supply thermal energy for these processes, the bulk of which use conventional resistance (Ohmic) or inductive circuits. One example of an apparatus that uses this type of heat producing device is the photocopy machine.

Referring to FIG. 1, in prior art photocopy machine 100 (hereinafter referred to as an image reproduction device), heater fuser rollers 105 are used to heat paper 110 to a temperature of between approximately 150° C. (300° F.) and 240° C. (460° F.). At this temperature, toner 115 will adhere to the page on which an image is being placed/printed. It is currently common for both fuser rollers 105 and pressure rollers 120 to contain resistance heaters. The surfaces of the rollers may be coated with a modified fluoroelastomer through which heat must be conducted to the roller surface in order to reach the paper. Similar fusing roller architectures may also include additional heated pressure rollers in contact with the fuser roller. The additional heated rollers may be necessary to help offset poor heat transfer from the embedded heater to the surface of the fuser roller. One of ordinary skill in the art will appreciate that it is not uncommon for more that 50% of the electrical power consumed by an image reproduction device is attributable to heating the device's fuser/pressure rollers.

### BRIEF DESCRIPTION OF THE DRAWINGS

FIG. 1 shows, in simplified schematic form, the paper flow path design of a prior art photocopy machine.

FIG. 2 shows, in simplified schematic form, the paper flow path design of an image reproduction device (e.g., a photocopy machine) in accordance with one embodiment of the invention.

FIG. 3 shows temperature verses time data for elastomer material loaded with between 0.0 wt-% and 4.0 wt-% at carbon nanotube material at 200 watts of applied microwave radiation.

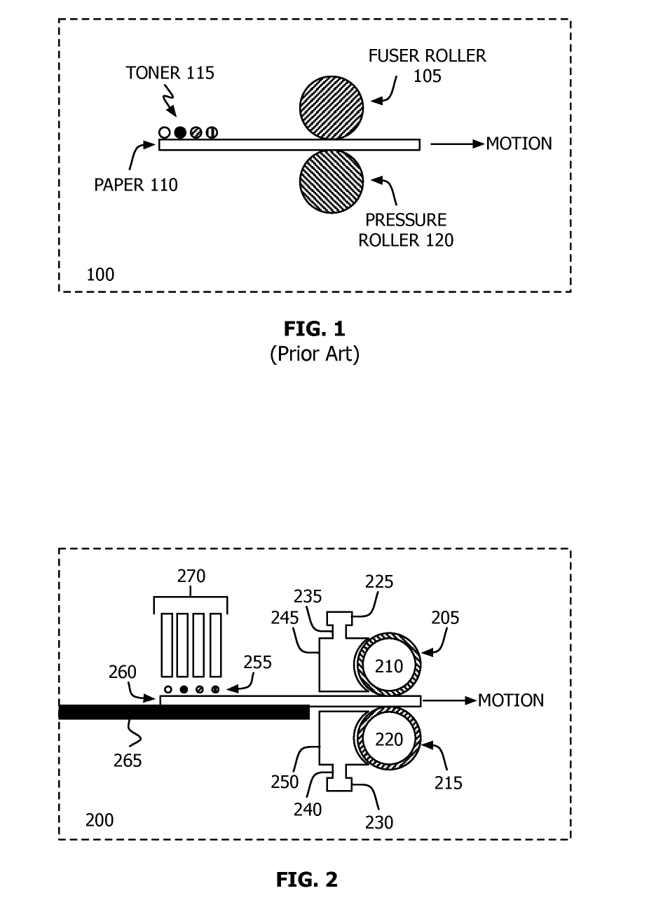

### DETAILED DESCRIPTION

Methods and devices in accordance with the invention utilize heat generated by the absorption of microwave energy through incorporation of carbon nanotechnologies. In one embodiment, microwave radiation may be used to heat carbon nanotubes embedded in an elastomer coating of an image reproduction device's roller mechanism.

Referring to FIG. 2, in one embodiment image reproduction device 200 employs elastomer coating 205 on fuser roller 210 and elastomer coating 215 on pressure roller 220. Elastomer coatings 205 and 215 are each loaded with (i.e., have embedded) carbon nanotube material. Energy from microwave sources 225 and 230 (e.g., magnetrons) are directed to rollers 210 and 210 through waveguide launchers 235 and 240 and microwave cavities 245 and 250; heating them so that toner 255 is heated and fixed onto paper 260 as it travels along paper transport assembly 265. Toner reservoirs 270 are shown for clarity. Rollers 210 and 220 may be constructed of metal and electrically grounded to microwave cavities 245 and 250. It will be recognized that microwave sources 225 and 230 may be separate sources or, alternatively, may utilize a common source.

In the illustrated embodiment, elastomer 205 and 215 may be a fluoroelastomer (a special purpose fluorocarbon-based synthetic rubber). Fluoroelastomers are a class of elastomers comprising copolymers of hexafluoropropylene (H FP) and vinyl idene fluoride (VDF or VF2), terpolymers of tetrafluoroethylene (TFE), vinylidene fluoride (VDF) and hexafluoropropylene (HFP). In general, fluoroelastomers exhibit a wide chemical resistance, especially in high temperature applications. One illustrative fluroelastomer is Viton® 6000. (VITON is a registered trademark of DuPont Dow Elastomers).

In one embodiment, elastomer coatings 205 and 215 are substantially the same. That is, they comprise the same elastomer material and are loaded (i.e., embedded or include) the same weight percentage of nanotube material. (As used herein, the phrase “X weight-percentage” means that if the total weight of the elastomer material—including nanotube material—applied to a roller is Y, X % of that is attributable to carbon nanotube material.) In another embodiment, each roller 210 and 220 may use a different composition of elastomer and/or a different loading of nanotube material. In still another embodiment, the pressure roller may not require heating and, therefore, not include or incorporate carbon nanotube material or waveguide launcher 230. One of ordinary skill in the art will recognize the specific decision regarding these issues depends upon the desired design goals of the particular image reproduction device being constructed. Nevertheless, given the information of this disclosure and the background and knowledge of one of ordinary skill in the art, these decisions would be possible without undue experimentation.

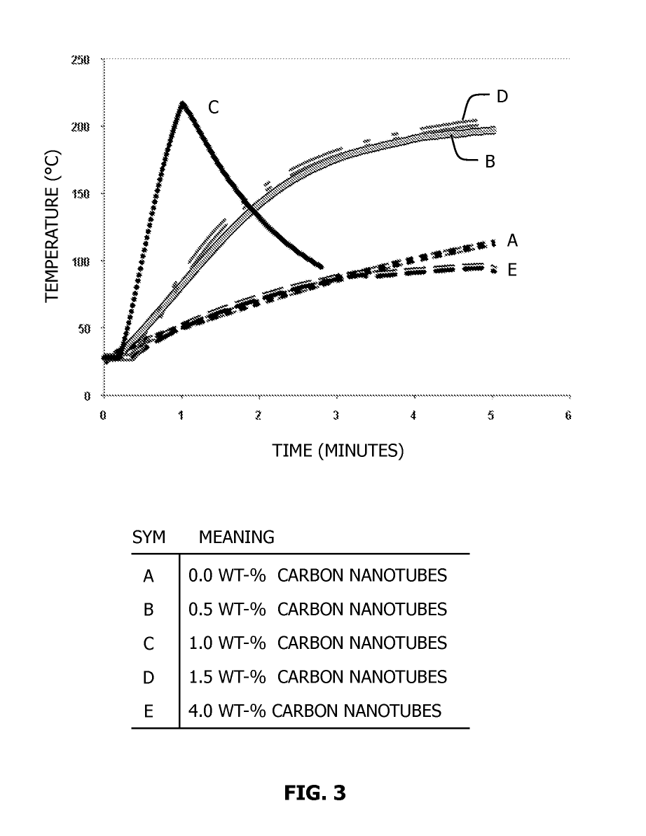

Referring to FIG. 3, temperature verses time data for a common elastomer material (Viton) used to cover rollers 210 and 220 is shown. (All data recorded using 200 watts of applied microwave energy at 2.45 GHz.) As shown, loading elastomer coating material 205 or 215 with between approximately 0.5 weight-percentage (wt-% or weight-%) to approximately 1.5 wt-% gives the best results (higher temperatures and faster times to reach these temperatures). That is, as the wt-% of carbon nanotube material is increased in the elastomer material applied to a roller, the ability of microwave radiation to heat the surface of the roller improves. Unexpectedly, it was found that in concentrations above approximately 1.5 wt-% the ability of microwave radiation to heat the rollers' surface showed little improvement and in concentrations above approximately 4.0 wt-% a decrease in heating ability was identified.

The type of carbon nanotubes that may be used to load the elastomer material applied to fuser roller 210 and pressure roller 220 may be multi-walled, functionalized multi-walled, raw single walled and purified single walled nanotubes, buckytubes, fullerene tubes, carbon fibrils, carbon nanotubes, stacked cones, horns, carbon nanofibers, vapor-grown carbon fibers, and combinations thereof. In addition, the nanotube material used may be chemically functionalized in a variety of manners. Carbon nanotubes used in this invention can be made by any known technique (e.g., arc method, laser oven, chemical vapor deposition, flames, HiPco, etc.) and can be in a variety of forms, e.g., soot, powder, fibers, “bucky papers,” etc. It is further noted that the use of pristine, unmodified nanotubes with unperturbed sidewall (which have a higher microwave cross-section of absorbance) can reduce the wt-% of carbon nanotube material needed.

In general, the elastomer coating used should be thick enough to incorporate or contain sufficient nanotube material that it can absorb substantially all of the applied microwave radiation. One of ordinary skill in the art will also recognize that the overall thickness and texture (its ability to nip material fed to it) of a roller's elastomer coating may also be affected by other design parameters such as operating speed, type of material being processed (e.g., paper or plastic) and the like.

As commonly used, the term microwave radiation refers to electromagnetic radiation having frequencies in the range of 0.3 GHz and 300 GHz. The more prevalent frequency used in microwave ovens is 2.54 GHz, which is also a common frequency for heating carbon nanotubes. Waveguide launchers 225 and 230 are metal, metal alloy or metal composite enclosures that direct microwave radiation towards elastomer coated rollers 210 and 220. Within device 200, one or more microwave generators 235 may be used to supply energy to waveguide launchers 225 and 230 through, for example, coaxial cable coupled at points A and B.

Microwave power may be continuous or pulsed. The surface temperature of rollers 210 and 220 may be controlled by changing the time, frequency, power or a combination of time/frequency and power of the microwave source. For example, microwave generator 235 may have a variable output with a range of 0-120 watts; however a higher wattage output may be required depending on the application. The pulse duration may be varied from, for example, 1 to 1,000 microseconds and the pulse repetition frequency from 2 to 1,000 pulses per second. In one embodiment, microwave generator/source 235 may be used to produce pulsed power to maintain a steady-state temperature at the surface of roller 210 and roller 220. Generator 235 can increase pulse duration, pulse repetition frequency or operate in continuous mode depending on the roller temperature requirement. In general, the roller surface temperature requirement is established by the requirements of the colorant or toner and the operating speed or the image reproduction device.

It will be understand that the basic principle of heating carbon nanotube material embedded in a roller to heat material is not limited to use in an image reproduction device. One of ordinary skill in the art would recognize that there are many processes that require the use of a heated roller; laminating, embossing, drying, annealing, calendering, and film orientation to name just a few. In these embodiments, the material being processed or heated may be paper, film, plastic, rubber, film and the like. Each of these processes may benefit from the use of embedding carbon nanotube material in, on or proximate to the surface of a roller, heating that material with microwave radiation, and transferring the absorbed microwave energy (in the form of heat) to a surface moved across the surface of the roller in accordance with the invention.

In the interest of clarity, not all features of an actual implementation are described in this specification. It will of course be appreciated that in the development of any such actual implementation (as in any hardware development project), numerous decisions must be made to achieve the developers' specific goals (e.g., compliance with system- and business-related constraints), and that these goals will vary from one implementation to another. It will be appreciated that such development effort might be complex and time-consuming, but would nevertheless be a routine undertaking for those of ordinary skill having the benefit of this disclosure. For example, while the decision of what type, energy production capability and operating mode (e.g., continuous, pulsed or mixed) the microwave source should be is a complex one, it would nevertheless be a routine engineering decision based on, for example, the type of toner and colorants used, the desired speed of operation and the expected or designed duty-cycle of the image reproduction device.

1. A material processing machine, comprising:
a material transport assembly;
a first roller configured to receive material from the material transport assembly, wherein at least a portion of an outer surface of the first roller is coated with an elastomer material having carbon nanotubes embedded therein; and
a first microwave source configured to supply microwave radiation to at least that portion of the outer surface of the first roller having carbon nanotubes embedded therein.

2. The material processing machine of claim 1, wherein the material comprises paper.

3. The material processing machine of claim 1, wherein the material comprises plastic.

4. The material processing machine of claim 1, wherein the material comprises rubber.

5. The material processing machine of claim 1, wherein the first microwave source comprises a magnetron.

6. The material processing machine of claim 1, wherein the elastomer material comprises a fluroelastomer material.

7. The material processing machine of claim 1, further comprising:
a second roller having an outer surface at least partially coated with an elastomer material having carbon nanotubes embedded therein, wherein the second roller is configured to receive material from the material transport assembly so that the material is positioned between the first and second rollers; and
a second microwave source configured to supply microwave radiation to at least that portion of the outer surface of the second roller having carbon nanotubes embedded therein.

8. The material processing machine of claim 7, wherein the elastomer material coating the second roller comprises a fluroelastomer material.

9. The material processing machine of claim 7, wherein the first and second microwave source comprise the same microwave source.

10. An image reproduction machine, comprising:
a paper transport assembly;
a fuser roller configured to receive paper from the paper transport assembly, wherein at least a portion of an outer surface of the fuser roller is coated with an elastomer material having carbon nanotubes embedded therein; and
a first microwave waveguide configured to direct microwave radiation to the fuser roller.

11. The image reproduction machine of claim 10, further comprising a first microwave source configured to supply microwave radiation to the first microwave waveguide.

12. The image reproduction machine of claim 11, further comprising one or more toner reservoirs configured to supply toner to paper before the paper is carried to the fuser roller by the paper transport assembly.

13. The image reproduction machine of claim 11, further comprising:
a pressure roller having an outer surface at least partially coated with an elastomer material having carbon nanotubes embedded therein, wherein the pressure roller is configured to receive paper from the paper transport assembly so that the paper is positioned between the fuser roller and the pressure roller; and
a second microwave waveguide configured to direct microwave radiation to the pressure roller.

14. The image reproduction device of claim 13, wherein the elastomer material comprises a fluroelastomer material.

15. The image reproduction machine of claim 13, further comprising a second microwave source configured to supply microwave radiation to the second microwave waveguide.

16. The image reproduction machine of claim 15, wherein the first and second microwave sources comprise the same microwave source.

17. The image reproduction machine of claim 16, wherein the microwave source comprises a pulsed microwave source.

18. The image reproduction machine of claim 10, wherein the elastomer material coating the outer surface of the fuser roller comprises between approximately 0.1 weight-% and 0.75 weight-% of carbon nanotube MATERIAL.

19. The image reproduction machine of claim 10, wherein the elastomer material coating the outer surface of the fuser roller comprises less than approximately 4 weight-% of carbon nanotube material.

20. The image reproduction machine of claim 13, wherein the elastomer material coating the outer surface of the fuser roller comprises a first loading of carbon nanotube material of between approximately 0.1 weight-% and 0.75 weight-% and the elastomer material coating the outer surface of the pressure roller comprises a second loading of carbon nanotube material of between approximately 0.1 weight-% and 0.75 weight-% and the first loading and the second loading of carbon nanotube material are different.

21. An image reproduction device, comprising:
a paper transport assembly;
a fuser roller having carbon nanotube material closely proximate to an outer surface thereof, the fuser roller configured to receive paper from the paper transport assembly;
a first microwave waveguide configured to direct microwave radiation to the outer surface of the fuser roller;
a pressure roller having carbon nanotube material closely proximate to an outer surface thereof, the pressure roller located adjacent to the fuser roller so that paper from the paper transport assembly travels between the fuser roller and the pressure roller;
a second microwave waveguide configured to direct microwave radiation to the outer surface of the pressure roller; and
a microwave source configured to provide microwave radiation to the first and second microwave waveguides.

22. The image reproduction device of claim 21, wherein the carbon nanotube material is held proximate to the outer surface of the fuser roller and the pressure roller by an elastomer material.

23. The image reproduction device of claim 22, wherein the elastomer material comprises a fluroelastomer material.

24. The image reproduction device of claim 21, wherein the microwave source comprises a pulsed microwave source.

25. The image reproduction device of claim 21, wherein the carbon nanotube material proximate the fuser roller is at a different loading than the carbon nanotube material proximate the pressure roller.

26. An image reproduction device, comprising:
a paper transport assembly;
a plurality of toner reservoirs configured to deliver toner fluid to paper being moved by the paper transport assembly;
a fuser roller having an outer surface at least partially coated with a first elastomer material having a first loading of carbon nanotubes, the fuser roller configured to receive paper from the paper transport facility assembly after the plurality of toner reservoirs;
a first microwave waveguide configured to direct microwave radiation to the fuser roller;
a pressure roller having an outer surface at least partially coated with a second elastomer material having a second loading of carbon nanotubes, the pressure roller located adjacent to the fuser roller so that paper from the paper transport assembly travels between the fuser roller and the pressure roller;
a second microwave waveguide configured to direct microwave radiation to the pressure roller; and
a microwave source configured to provide microwave radiation to the first and second microwave waveguides.

27. The image reproduction device of claim 26, wherein the first and second elastomer material comprise the same elastomer material.

28. The image reproduction device of claim 27, wherein the elastomer material comprises a fluroelastomer material.

29. The image reproduction device of claim 26, wherein the first loading of carbon nanotubes comprises between approximately 0.1 weight-% and 0.75 weight-% of the elastomer material.

30. The image reproduction device of claim 29, wherein the second loading of carbon nanotubes comprises between approximately 0.1 weight-% and 0.75 weight-% of the elastomer material and is the same as the first loading of carbon nanotubes.

31. The image reproduction device of claim 26, wherein the microwave source comprises a pulsed microwave source.
